(19) United States
(12) Patent Application Publication
(10) Pub. No.: US 2025/0265263 A1
(43) Pub. Date: Aug. 21, 2025

(54) ELECTRONIC DATA ANALYSIS SYSTEM AND METHOD

(71) Applicant: Grafa Pty Ltd., West Perth (AU)

(72) Inventor: Heidi Cuthbert, West Perth (AU)

(21) Appl. No.: 19/069,484

(22) Filed: Mar. 4, 2025

Related U.S. Application Data
(63) Continuation of application No. 18/034,481, filed on Apr. 28, 2023, now abandoned.

(30) Foreign Application Priority Data
Oct. 30, 2020 (AU) 2020903964

(51) Int. Cl. G06F 16/25; G06F 16/2458; G06F 16/248; G06F 16/28; G06Q 30/0201

(52) U.S. Cl. CPC G06F 16/252; G06F 16/2471; G06F 16/248; G06F 16/285; G06Q 30/0201

(57) ABSTRACT

An electronic data analysis method including at least one server, the electronic data analysis method comprising the steps of: a) Receiving, from an electronic device associated with a user to an electronic data analysis system, a search query including one or more search query terms; b) Maintaining an electronic search term database in association with the electronic data analysis system, the search term database comprising a plurality of search terms; c) Identifying, using the electronic data analysis system, one or more relevant search terms from the plurality of search terms in the electronic search term database based on the one of more search query terms; d) Sending, using the electronic data analysis system, a search request related to the one or more relevant search terms to a plurality of data sources external to the electronic data system; e) Receiving, using the electronic data system, data associated with the one or more relevant search terms from the plurality of data sources; f) Assigning, using the electronic data system, the data retrieved from the plurality of data sources into a plurality of data visualisation categories; and g) Displaying, using the electronic data system, the plurality of data visualisation categories on the electronic device.

### CROSS-REFERENCE TO RELATED APPLICATIONS

This application is a continuation of and claims priority to U.S. patent application Ser. No. 18/034,481, filed Apr. 28, 2023, which is a national stage entry of International Patent Application PCT/AU2021/051276, filed on Oct. 29, 2021, which claims priority to Australia Patent Application 2020903964, filed on Oct. 30, 2020. U.S. patent application Ser. No. 18/034,481, International Patent Application PCT/AU2021/051276, and Australia Patent Application 2020903964 are incorporated herein by reference.

### TECHNICAL FIELD

The present invention relates to an electronic data analysis system and method. In particular, the present invention relates to an electronic data and analysis system and method that draws data from multiple sources.

### BACKGROUND ART

Many decisions, including financial decisions, are made following the collection and analysis of relevant data. This process is largely the same regardless of whether decisions are being made by individuals, commercial entities, governments and so on.

However, the process of searching, charting, visualising and analysing data is rapidly becoming a complex problem in today's environment where a large amount of data is available from numerous different sources. This is particularly relevant when multiple sources of information are being incorporated into the analysis, and especially even when the multiple sources of information are disparate sources (such as economic, financial and government).

While in theory it may be possible to locate and visualise information from multiple sources using a standard search engine, it is generally not possible to perform complex tasks such as comparing data and analysing trends.

Thus, there would be an advantage if it were possible to provide an electronic data analysis method and system that allowed for the collection, analysis and visualisation of data from multiple disparate sources quickly and easily and at relatively low cost.

It will be clearly understood that, if a prior art publication is referred to herein, this reference does not constitute an admission that the publication forms part of the common general knowledge in the art in Australia or in any other country.

### SUMMARY OF INVENTION

The present invention is directed to an electronic data analysis method and system which may at least partially overcome at least one of the abovementioned disadvantages or provide the consumer with a useful or commercial choice.

With the foregoing in view, in a first aspect the present invention resides broadly in an electronic data analysis method including at least one server, the electronic data analysis method comprising the steps of:
a) Receiving, from an electronic device associated with a user to an electronic data analysis system, a search query including one or more search query terms;
b) Maintaining an electronic search term database in association with the electronic data analysis system, the search term database comprising a plurality of search terms;
c) Identifying, using the electronic data analysis system, one or more relevant search terms from the plurality of search terms in the electronic search term database based on the one of more search query terms;
d) Sending, using the electronic data analysis system, a search request related to the one or more relevant search terms to a plurality of data sources external to the electronic data system;
e) Receiving, using the electronic data system, data associated with the one or more relevant search terms from the plurality of data sources;
f) Assigning, using the electronic data system, the data retrieved from the plurality of data sources into a plurality of data visualisation categories; and
g) Displaying, using the electronic data system, the plurality of data visualisation categories on the electronic device.

The electronic device may be of any suitable form. For instance, the electronic device may comprise a desktop computer or server. Alternatively, the electronic device may be a portable electronic device, such as a mobile telephone, a computing tablet, a smart watch and the like. In this embodiment of the invention, the electronic data analysis system may be operated or housed on the electronic device. Alternatively, the user may access an electronic interface associated with the electronic data analysis system through, for instance, a website or an electronic application downloaded to the electronic device. Thus, in this embodiment of the invention, it is envisaged that the electronic data analysis system may be housed on one or more servers.

The user may be any suitable entity. For instance, the user may be an individual, a group of two or more individuals, a corporate entity, a group of two or more corporate entities, a trust, a partnership or the like.

The electronic data analysis system preferably includes a plurality of electronic interfaces with which the user may interact. The electronic data analysis system may be open to any user to access without registration. More preferably, however, the electronic data analysis system may require a user to open an account with the electronic data analysis system before being provided with access to the electronic data analysis system. Preferably, registration may be automated using the electronic data analysis system (for instance using an app or a website on which the electronic data analysis system is provided).

In embodiments of the invention in which registration is automated, registration of a user may be limited to users that can supply one or more predetermined pieces of information. For instance, a user may need to supply one or more pieces of information such as name, date of birth, email address or physical address. In addition, a user may be required to associate one or more payment credentials (financial institution account, credit or debit card, an account with an online payment system, a gift card, or any other account in which money may be withdrawn or deposited) so that funds may be transferred from the payment credential to the electronic data analysis system, or more specifically, with a financial institution account associated with the electronic data analysis system.

The payment credential may be registered by, for instance, entering the name of the financial institution, the branch number, the account number, the credit or debit card number, the expiry date of the credit or debit card, the name of the holder or the like, or any suitable combination thereof.

It is envisaged that, once the user has entered the required information into the registration interface, the electronic data analysis system may access one or more electronic databases to verify that the information supplied by the user is valid. In some embodiments, the electronic database may be databases maintained externally to the electronic data analysis system, such as an electronic database maintained by a government authority (such as a government authority that issues motor vehicle licences, an authority that maintains company and business registrations and the like), a financial institution (including banks, building societies, credit unions, credit card issuers and the like), a telephone directory, electoral roll or the like, or any suitable combination thereof. In some embodiments of the invention, the electronic data analysis system may charge an amount of money against a credit or debit card in order to test the validity of the card details.

If the electronic data analysis system is unable to verify that the information supplied by the user is valid, the user's application for registration may be refused. Alternatively, if the electronic data analysis system is able to verify that the information supplied by the user is valid, the user's registration may be accepted.

The user may amend or cancel their account with the electronic data analysis system as required. In other embodiments, the electronic data analysis system may cancel a user's account under certain circumstances. For instance, the electronic data analysis system may cancel an account in the event of fraudulent activity, inactivity over a predetermined period of time and so on.

It is envisaged that the electronic data analysis system may include one or more electronic registration interfaces via which a user may complete the registration process. It is envisaged that the one or more electronic registration interfaces may be configured to allow a user to enter the information required to complete the registration process.

As previously stated, the user sends a search query including one or more search query terms to the electronic data analysis system from the electronic device. The search query may be in any suitable form. For instance, the search query may be sent in the form of an SMS, MMS, voicemail, email or the like. More preferably, however, the electronic data analysis system may be provided with one or more electronic search interfaces into which the user may enter the search query. The search query may be entered in any suitable form, such as words, sentences, images, videos, codes or the like, or any suitable combination thereof. In a preferred embodiment of the invention, the search query may be entered in any suitable language, including in languages that make use of non-Roman characters.

In some embodiments of the invention, the search query may consist of the search query terms. Thus, the user may enter the search query in the form of one or more search query terms. The search query terms may be of any suitable form, such as, but not limited to, keywords, names, locations, numbers, company identification information, stock symbols, currency codes or the like, or any suitable combination thereof. In other embodiments, the search query may comprise one or more search query terms. In this embodiment, it is envisaged that the search query may comprise, for example, one or more sentences of which one or more words, letters, numbers or the like comprise the search query terms.

As previously stated, the electronic data analysis system identifies one or more relevant search terms from a plurality of search terms in an electronic search term database based on the one of more search query terms. This may be achieved in any suitable manner. In some embodiments of the invention, the user may be required to identify search query terms in the search query. Alternatively, the electronic data analysis system may be configured to identify search query terms within the search query.

The electronic data analysis system may be configured to identify search query terms within the search query in any suitable manner. For instance, the electronic data analysis system may be configured to transmit the search query to the electronic search term database to determine whether any search query terms within the search query match search terms within the electronic search term database.

In another embodiment, the electronic data analysis system may comprise one or more machine learning modules. The machine learning modules may use any suitable algorithm, although in a preferred embodiment of the invention the one or more machine learning modules may utilise natural language processing techniques in order to identify and/or process search query terms obtained from the search query.

In embodiments in which the electronic data analysis system comprises one or more machine learning modules, it is envisaged that the machine learning modules may comprise an intelligent agent including artificial intelligence, machine learning algorithms, deep learning models, computer vision algorithms, and the like. It is envisaged that the machine learning modules may be configured to identify search query terms within the search query and that, as the number of search queries received by the electronic data analysis system increases over time, the ability of the machine learning modules to rapidly, accurately and/or efficiently identify search query terms within the search query may improve.

The electronic search term database may be associated with the electronic data analysis system in any suitable manner. For instance, the electronic search term database may be electronically connected to the electronic data analysis system via one or more cables, cords or the like. Alternatively, the electronic search term database and the electronic data analysis system may be located remote to one another but may be in electronic communication with one another using any suitable technique, such as a WiFi connection, Bluetooth connection or the like.

As previously stated, the search term database comprises a plurality of search terms. The search terms may be entered into the search term database by an administrator (for instance as training data), may be developed over time based on data received from the plurality of data sources external to the electronic data system and/or search query terms received from one or more users, or any suitable combination thereof.

In some embodiments of the invention, the one or more relevant search terms may be identified only when there is correspondence between a search query term and a search term in the electronic search term database. More preferably, however, a relevant search term may be identified even when there is not correspondence between a search query term and a search term in the electronic search term database. Thus, the electronic data analysis may be configured to identify relevant search terms based on similarity between a search query term and a search term in the electronic search term database (for instance, using fuzzy logic algorithms and the like). Alternatively, when the electronic data analysis system comprises one or more machine learning modules, the one or more machine learning modules may be configured to identify relevant search terms based on one or more factors. Any suitable factors may be considered, such as similarity to search terms in the electronic search term database, previous search queries received from the same user, previous search queries received from other users having one or more similarities to the user (including, but not limited to, age, geographic location, gender and the like), or any suitable combination thereof. Thus, it is envisaged that the machine learning modules may be configured to identify relevant search terms based on the search query terms and that, as the number of search queries received by the electronic data analysis system increases over time, the ability of the machine learning modules to rapidly, accurately and/or efficiently identify relevant search terms from the search query terms may improve

As previously stated, the electronic data analysis system sends a search request related to the one or more relevant search terms to a plurality of data sources external to the electronic data system. The plurality of data sources may be of any suitable form, and it is envisaged that the nature of the data sources may vary depending on the nature of the search request. However, in some embodiments of the invention, the plurality of data sources may include media outlets, government departments and agencies, corporate entities, financial institutions, stock exchanges, and the like. More specifically, the plurality of data sources may comprise one or more servers, databases or the like belonging to one or more media outlets, government departments and agencies, corporate entities, financial institutions, stock exchanges, and the like.

Preferably, the search request is communicated electronically to the plurality of data sources. Preferably, the search request is communicated electronically to the plurality of data sources in a manner that allows for the retrieval of data from the plurality of data sources autonomously. The autonomous retrieval of data from the plurality of data sources may be achieved in any suitable manner. However, in a preferred embodiment of the invention, the electronic data analysis system may comprise one or more application programming interfaces (APIs) configured to facilitate electronic communication between the electronic data analysis system and the plurality of data sources. More specifically, the electronic data analysis system may comprise one or more application programming interfaces (APIs) configured to facilitate electronic communication between the electronic data analysis system and one or more servers, databases or the like associated with the plurality of data sources.

It is envisaged that the search request may be configured to interrogate the one or more servers, databases or the like associated with the plurality of data sources in order to locate and retrieve data relating to the one or more relevant search terms. Preferably data located by the search request may be retrieved by the electronic data analysis system via the one or more APIs.

Data retrieved from the plurality of external databases may be of any suitable form. For instance, the data may be in human-readable form, machine-readable form, or a combination of the two.

In a preferred embodiment of the invention, the data received from the plurality of external databases may be stored in the electronic search term database. Preferably, one or more search terms are associated with the data stored in the electronic search term database. In this way, when a new search query is received, data associated with a particular search query term may be retrieved from the electronic search term database without the requirement to interrogate the plurality of external data sources. Thus, the speed with which data may be provided to the user may be improved.

Although previously-received data may be retrieved from the electronic search term database, it is envisaged that the electronic data analysis system will always send a search request to the plurality of external data sources in order to locate and retrieve new data associated with the relevant search terms. It will be understood that by “new data” it is meant any data relating to a relevant search term that has been created since the previous occasion on which data relating to the relevant search term was received from the plurality of external data sources. In this way, the volume of data received by the electronic data analysis system may be minimised for each subsequent search request related to a particular relevant search term. Not only does this reduce the costs associated with the transfer of data, but it also reduces the time taken to receive the data from the plurality of external data sources, which in turn may reduce the time taken to provide the data to the user.

The data visualisation categories into which the data received by the electronic data analysis system is assigned may be of any suitable type. For instance, the data may be assigned to categories based on the format of the data (e.g. videos, documents, articles, government grants or permits, charts, graphs and the like), the source of the data, the purpose of the data and/or the type of data (e.g. company announcements, media articles, stock trends, financial information, property information and so on).

It is envisaged that, in some embodiments of the invention, the data may be assigned to the data visualisation categories based at least in part on the purpose for which the data is to be used. For instance, in a specific embodiment of the invention, the data may be used to assist a user in determining whether to invest in a company, capital project, construction project, mining project or the like, or any suitable combination thereof. Thus, it is envisaged that the data received from the plurality of external data sources may be categorised in a manner that would assist a user in determining whether or not an investment should be made. Thus, in this embodiment of the invention, the plurality of data visualisation categories may include media coverage (articles, videos and the like), company information (such as press releases, financial statements, annual reports, shareholder reports and the like), government information (such as permits, licenses, grants, intellectual property reports, ownership, fines, legal proceedings and the like), stock exchange and other financial information (such as stock prices, commodity prices, stock index values, currency exchange rates, cryptocurrency exchange rates and the like) and so on.

The data may be displayed to the user in any suitable form, although it is preferred that the data may be displayed to the user in human-readable form. The data may be displayed to the user in the form of text, images, videos, charts, graphs and the like, or any suitable combination thereof.

In some embodiments of the invention, the data may be displayed to the user in the form in which it is received from the plurality of external data sources. In other embodiments of the invention, however, the data may be analysed by the electronic data analysis system before being displayed to the user. The data may be analysed in any suitable manner. For instance, the data may be analysed so as to identify trends in the data not otherwise identified in the data itself. By way of example, if a user is seeking a recommendation as to whether to invest in a target stock or target company, the electronic data analysis system may provide a recommendation based on one or more calculations using the data retrieved from the plurality of data sources. In this example, the electronic data analysis system may use data such as one or more of company financial information, stock market index trends, trends in commodity prices, announcements made by or in relation to competitor companies to the target company, currency exchange rates, financial forecasts in any country in which the target company operates or intends to expand, and so on in order to develop short-, medium- and/or long-term forecasts for the value of the target company or target stock. Thus, the electronic data analysis system may be configured to identify and/or extract relevant data obtained from each of the plurality of external data sources for analysis. Preferably, the electronic data analysis system is configured to analyse the data obtained from each of the plurality of external data sources to generate one or more reports relating to the search query terms. The one or more reports may include information relating to trends relating to the search query terms identified from the data obtained from each of the plurality of external data sources. The trends may include past and current trends relating to the search query terms. Preferably, however, the trends include an estimate or extrapolation of future trends associated with the search query terms.

Preferably, the data visualisation categories are displayed on the electronic device. To achieve this, it is envisaged that the electronic data analysis system may comprise one or more display interfaces on which the data visualisation categories are displayed. Preferably, a user may access the one or more display interfaces using the electronic device. Preferably, the one or more display interfaces may be viewed by the user on a display associated with the electronic device, such as a screen, monitor or the like.

In some embodiments, a display interface may be provided for each data visualisation category. Thus, the user may move between display interfaces in order to view the data contained in each data visualisation category.

It is envisaged that the data may be displayed to the user at any suitable time. For instance, the data may be displayed to the user as soon as possible after the search query is sent. Alternatively, the user may elect to send a search query and review the data received from the electronic data analysis system on the next occasion that the user logs into or checks their account.

In some embodiments of the invention, the user may send search queries on an as-needs basis. Alternatively, the user may set up recurring search queries so that the data is regularly updated. For instance, the user may set up their account to send a search query weekly, daily, hourly or any other suitable period of time.

In a second aspect, the invention resides broadly in an electronic data analysis system including at least one processor and at least one non-transitory computer readable storage medium storing instructions thereon, that, when executed by the at least one processor, cause the system to:
Receive, from an electronic device associated with a user, a search query including one or more search query terms;
Identify one or more relevant search terms from a plurality of search terms in an electronic search term database based on the one of more search query terms;
Send a search request related to the one or more relevant search terms to a plurality of data sources external to the electronic data system;
Receive data associated with the one or more relevant search terms from the plurality of data sources;
Assign the data retrieved from the plurality of data sources into a plurality of data visualisation categories; and
Display the plurality of data visualisation categories on the electronic device.

In a preferred embodiment, the electronic device may comprise devices such as, but not limited to, computers, mobile telephones, computing tablets, smart watches and the like.

In a third aspect, the invention resides broadly in a method, in a communication environment including a third-party transaction server comprising a processor and a memory, for importing and sorting data to an electronic data analysis system, the method comprising:
Receiving, by the third-party transaction server, a search query including one or more search query terms from an electronic device associated with a user;
Identifying, by the third-party transaction server, one or more relevant search terms from a plurality of search terms in an electronic search term database associated with the electronic data analysis system based on the one of more search query terms;
Sending, by the third-party transaction server, a search request related to the one or more relevant search terms to a plurality of data sources external to the electronic data system;
Receiving, by the third-party transaction server, the data from the one of more electronic databases; and
Sorting, by the third-party transaction server, the data into a plurality of data visualisation categories.

In a fourth aspect, the invention resides broadly in a third-party transaction server for importing and sorting data to an electronic data analysis system, the third-party transaction server comprising:
A file server configured to receive data from one or more data sources external to the electronic data analysis system;
A database that stores the received data;
A data backend communicatively coupled to the database, the data backend managing access and retrieval of the data;
A data collection module associated with the data backend, the data collection device configured to collect and sort the data into a plurality of data visualisation categories; and
A user interface communicatively couple to the data backend and to a user client device, the user interface configured to send a search query including one or more search query terms to the data backend from the user client device, and receive a plurality of data visualisation categories related to the one or more search query terms from the data backend.

The present invention provides numerous advantages. Firstly, the present invention provides the user with collected and/or analysed data from a plurality of disparate data sources. Thus, the present invention improves the speed and efficiency with which a user can view and understand information from a wide variety of sources. This in turn increases the speed of decision making, which can be extremely important in time-critical situations. Secondly, the ability of the present invention to improve the identification of relevant search terms over time means that the accuracy of the data displayed to the user will continually improve, resulting in a reduction in less relevant data being displayed to the user in comparison to a user conducting their own searches of disparate sources of data. Thirdly, the present invention analyses data collected from the plurality of data sources in a manner that is not possible when, for instance, searching the data sources individually. Thus, the present invention provides a deeper and more thorough analysis of the data than could otherwise be achieved. Finally, as the number of search queries received from users increases, the more data will have already been collected and/or analysed by the present invention. Thus, the speed with which subsequent search queries may be processed (and the relevant data displayed to the user) will increase. In addition, this also means that data transfer costs will decrease over time.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a schematic view of an electronic data analysis method according to an embodiment of the present invention.

FIGS. 2 to 6 illustrates user interfaces of an electronic data analysis system according to embodiments of the present invention.

### DESCRIPTION OF EMBODIMENTS

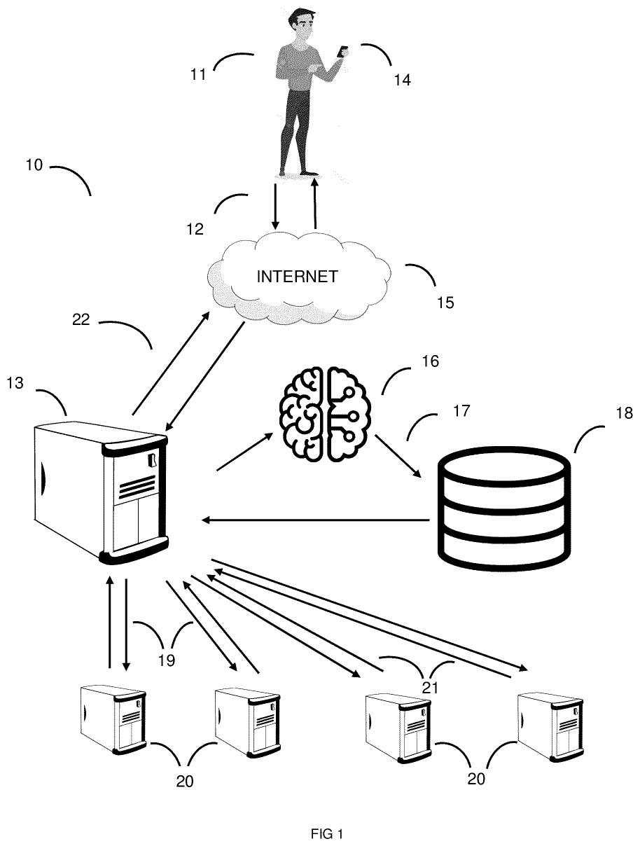

FIG. 1 illustrates a schematic view of an electronic data analysis method 10 according to an embodiment of the present invention. In FIG. 1 a user 11 sends a search query 12 to an electronic data analysis system. The electronic data analysis system is housed on a server 13 and is accessed by the user 11 from the user's electronic device 14. In FIG. 1, the user's electronic device 14 is a mobile telephone, and the user 11 accesses the electronic data analysis system through a remote connection via the internet 15 between the electronic device 14 and the server 13.

The search query 12 is a request for information regarding a topic (such as a company, stock or the like) and includes one or more search query terms. Upon receipt of the search query 12, a machine learning module 16 reviews the search query 12 in order to identify relevant search terms 17 within the search query 12. The relevant search terms 17 are search terms for which data is held within an electronic search term database 18 associated with the server 13.

The relevant search terms 17 are identified from the search query terms contained in the search query 12 based on a number of factors, such as, but not limited, similarity (similar words, similar geographical areas, similar companies, similar names of individuals etc.) to existing search terms in the electronic search term database 18, previous search queries received from the same user, previous search queries received from other users having one or more similarities to the user (including, but not limited to, age, geographic location, gender and the like, or any suitable combination thereof), trending keywords (for instance in the media or on social media) and so on, or any suitable combination thereof.

Once the relevant search terms 17 have been identified, existing data in the electronic search term database 18 (if such data exists) is sent to the server 13. In addition, search requests 19 including the relevant search terms 17 are sent by the server 13 to a plurality of data sources 20 external to the electronic data analysis system. The external data sources 20 may be of any similar type, but are typically servers associated with government agencies/departments, stock exchanges, media outlets, financial institutions, economic groups or organisations, companies and the like.

The electronic data analysis system communicates with the external data sources 20 via one or more APIs in order to identify and retrieve data from the external data sources 20 relating to the search requests 19. Data 21 received by the server is stored to the electronic search term database 18 according to the relevant search term 17 to which it relates.

Data 21 that is received from the external data sources 19, along with data received from the electronic search term database 18 is assigned, using the server 13 forming part of the electronic data system, to a plurality of data visualisation categories. The categorised data 22 is then displayed on a display of the electronic device 14 via one or more display interfaces.

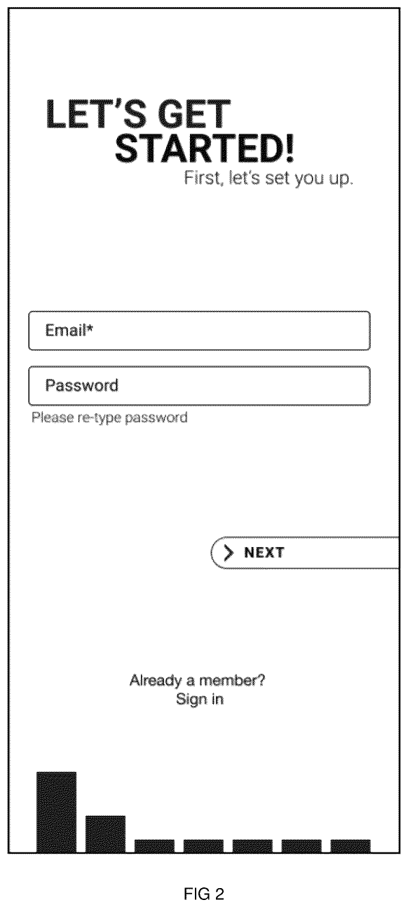

FIGS. 2 to 6 illustrates user interfaces of an electronic data analysis system according to embodiments of the present invention. The user interfaces are displayed on an electronic device (and more specifically a mobile telephone) of a user when using the electronic data analysis system.

FIG. 2 illustrates a user interface that allows a user to access their account with the electronic data analysis system by logging into the electronic data analysis system. The user enters their username and password registered with the electronic data analysis system in order to log in.

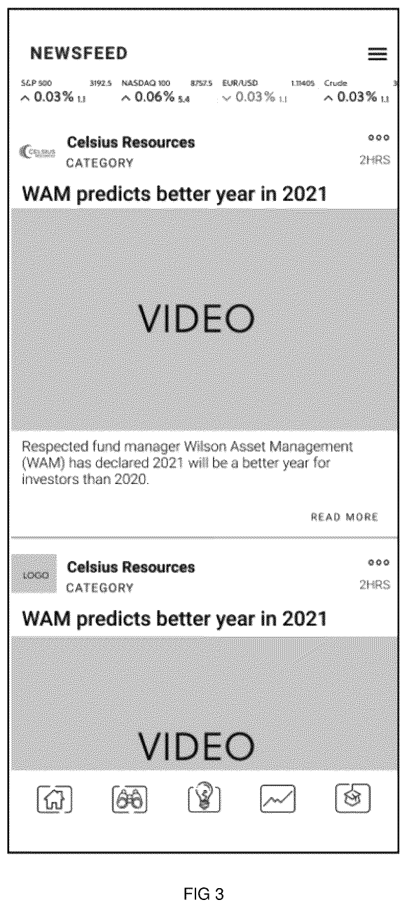

Upon logging into the electronic data analysis system the user is provided with a newsfeed interface as illustrated in FIG. 3. The data provided in the newsfeed interface may be common to all users or may be customised by each user depending on their interests. Alternatively, the newsfeed interface may be customised by the electronic data analysis system based on a knowledge of a user's interests determined by search queries that the user has sent to the electronic data analysis system.

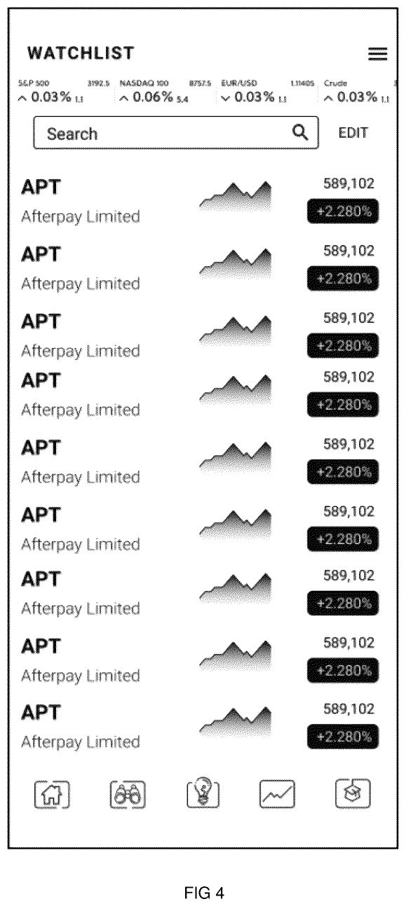

FIG. 4 illustrates a watchlist interface of the electronic data analysis system. In the watchlist interface, the user keeps a list of stocks and stock market indexes in which the user has an interest. The watchlist interface is one of the visualisation categories of data, in that the watchlist interface graphically illustrates changes in stock prices and stock market index values over a period of time, allowing a user to identify trends in the data.

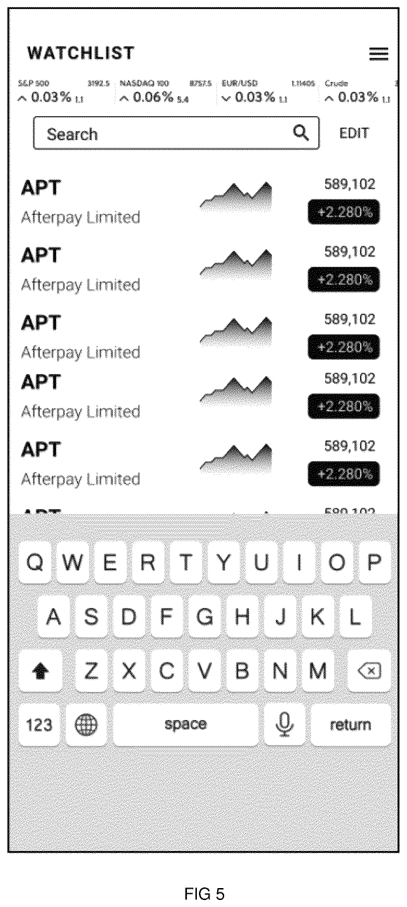

In the embodiment of the invention shown in FIG. 4, the stocks and indexes have been added to the watchlist interface by the user sending a search query relating to each stock and index to the electronic data analysis system. As seen in FIG. 5, the user may generate a search query through the watchlist interface for a different stock or index, or even for an update for a stock or index already in the watchlist interface.

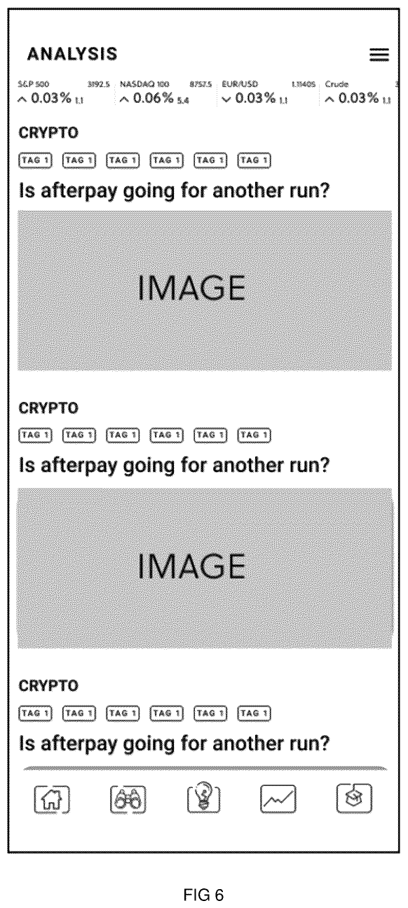

FIG. 6 illustrates an analysis interface of the electronic data analysis system. The analysis interface is one of the visualisation categories of data, in that the analysis interface collects and displays articles, announcements, media releases and so on relating to a stock or stock market index, allowing a user to identify trends in the data.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An electronic data analysis method including at least one server, the electronic data analysis method comprising steps of:
a) receiving, from an electronic device associated with a user to an electronic data analysis system, a search query including one or more search query terms;
b) maintaining an electronic search term database in association with the electronic data analysis system, the electronic search term database comprising a plurality of search terms;
c) identifying, using the electronic data analysis system, one or more relevant search terms from the plurality of search terms in the electronic search term database based on the one or more search query terms, wherein the identifying comprises:
determining whether the search query has been previously received;
when the search query has been previously received, identifying one or more search terms identified as relevant when the search query was previously received as the one or more relevant search terms; and
when the search query has not been previously received, comparing the one or more search query terms to the plurality of search terms in the electronic search term database to identify the one or more relevant search terms;
d) sending, using the electronic data analysis system, a search request related to the one or more relevant search terms to a plurality of data sources external to the electronic data analysis system;
e) receiving, using the electronic data analysis system, data associated with the one or more relevant search terms from the plurality of data sources;
f) assigning, using the electronic data analysis system, the data received from the plurality of data sources into a plurality of data visualisation categories; and
g) displaying, using the electronic data analysis system, the plurality of data visualisation categories on the electronic device.

2. The electronic data analysis method of claim 1, wherein the one or more search query terms comprise keywords, names, locations, numbers, company identification information, stock symbols, currency codes, or a combination thereof and the electronic data analysis system is provided with one or more electronic search interfaces into which the user enters the search query.

3. (canceled)

4. The electronic data analysis method according to claim 1, wherein the electronic data analysis system comprises one or more machine learning modules configured to identify the one or more search query terms within the search query.

5. The electronic data analysis method according to claim 4, wherein the one or more machine learning modules utilise natural language processing techniques in order to at least one of identify or process the one or more search query terms obtained from the search query.

6. The electronic data analysis method according to claim 4, wherein the one or more machine learning modules are configured to identify the one or more relevant search terms based on one or more factors.

7. The electronic data analysis method according to claim 6, wherein the one or more factors include similarity to the plurality of search terms in the electronic search term database, previous search queries received from the user, previous search queries received from other users having one or more similarities to the user, or a combination thereof.

8. The electronic data analysis method according to claim 1, wherein the plurality of data sources comprises one or more servers or databases belonging to one or more media outlets, government departments and agencies, corporate entities, financial institutions or stock exchanges.

9. The electronic data analysis method according to claim 1, wherein the electronic data analysis system comprises one or more application programming interfaces (APIs) configured to facilitate electronic communication between the electronic data analysis system and the plurality of data sources.

10. The electronic data analysis method according to claim 1, wherein the data received from the plurality of data sources is stored in the electronic search term database and is assigned into the plurality of data visualisation categories based on at least one of a format of the data or a purpose for which the data is to be used.

11. (canceled)

12. The electronic data analysis method according to claim 1, wherein the electronic data analysis system analyses the data received from the plurality of data sources prior to displaying the plurality of data visualisation categories.

13. The electronic data analysis method according to claim 12, wherein the electronic data analysis system is configured to at least one of identify or extract relevant data obtained from each of the plurality of data sources for analysis.

14. The electronic data analysis method according to claim 12, wherein the electronic data analysis system is configured to analyse the data received from each of the plurality of data sources to generate one or more reports relating to the one or more search query terms.

15. The electronic data analysis method according to claim 14, wherein the one or more reports include information relating to trends relating to the one or more search query terms identified from the data received from each of the plurality of data sources.

16. The electronic data analysis method according to claim 15, wherein the trends include an estimate or extrapolation of future trends associated with the one or more search query terms.

17. The electronic data analysis method according to claim 1, wherein the electronic data analysis system comprises one or more display interfaces on which the plurality of data visualisation categories are displayed.

18. The electronic data analysis method according to claim 1, wherein the electronic data analysis system is configured to provide the user with one or more additional reports generated based on a second search query received from another user of the electronic data analysis system.

19. The electronic data analysis method according to claim 17, wherein the one or more display interfaces are viewed by the user on a display associated with the electronic device, and the electronic device comprises a computer, mobile telephone, computing tablet, or smart watch.

20. The electronic data analysis method according to claim 17, wherein a display interface is provided for each of the plurality of data visualisation categories.

21. (canceled)

22. An electronic data analysis system including at least one processor and at least one non-transitory computer readable storage medium storing instructions thereon, that, when executed by the at least one processor, cause the electronic data analysis system to:
receive, from an electronic device associated with a user, a search query including one or more search query terms;
identify one or more relevant search terms from a plurality of search terms in an electronic search term database based on the one or more search query terms, wherein the identifying comprises:
determining whether the search query has been previously received;
when the search query has been previously received, identifying one or more search terms identified as relevant when the search query was previously received as the one or more relevant search terms; and
when the search query has not been previously received, comparing the one or more search query terms to the plurality of search terms in the electronic search term database to identify the one or more relevant search terms;
send a search request related to the one or more relevant search terms to a plurality of data sources external to the electronic data analysis system;
receive data associated with the one or more relevant search terms from the plurality of data sources;
assign the data received from the plurality of data sources into a plurality of data visualisation categories; and
display the plurality of data visualisation categories on the electronic device.

23. A communication environment including a third-party transaction server comprising a processor and a memory, for importing and sorting data to an electronic data analysis system according to a method comprising:
receiving, by the third-party transaction server, a search query including one or more search query terms from an electronic device associated with a user;
identifying, by the third-party transaction server, one or more relevant search terms from a plurality of search terms in an electronic search term database associated with the electronic data analysis system based on the one or more search query terms, wherein the identifying comprises:
determining whether the search query has been previously received;
when the search query has been previously received, identifying one or more search terms identified as relevant when the search query was previously received as the one or more relevant search terms; and
when the search query has not been previously received, comparing the one or more search query terms to the plurality of search terms in the electronic search term database to identify the one or more relevant search terms;
sending, by the third-party transaction server, a search request related to the one or more relevant search terms to a plurality of data sources external to the electronic data analysis system;
receiving, by the third-party transaction server, the data from the plurality of data sources; and
sorting, by the third-party transaction server, the data into a plurality of data visualisation categories.
